(19) United States
(12) Patent Application Publication
(10) Pub. No.: US 2024/0348712 A1
(43) Pub. Date: Oct. 17, 2024

(54) UNDERWATER COMMUNICATION INTERFACE APPARATUS

(71) Applicant: KING ABDULLAH UNIVERSITY OF SCIENCE AND TECHNOLOGY, Thuwal (SA)

(72) Inventors: Michael Lee BERUMEN, Thuwal (SA); Wesly BILLMAN, Lake Havasu City, AZ (US); José Ilton DE OLIVEIRA FILHO, Thuwal (SA); James PEÑA, Vista, CA (US); Khaled Nabil SALAMA, Thuwal (SA)

(21) Appl. No.: 18/293,075

(22) PCT Filed: Jul. 27, 2022
(86) PCT No.: PCT/IB2022/056955

§ 371 Date: Jan. 29, 2024

Related U.S. Application Data
(60) Provisional application No. 63/227,662, filed on Jul. 30, 2021.

(51) Int. Cl. H04M 1/18; H04B 1/3888; H04B 11/00; H04M 1/72409

(52) U.S. Cl. CPC H04M 1/18; H04B 1/3888; H04B 11/00; H04M 1/72409

(57) ABSTRACT

An underwater communication interface apparatus includes a first waterproof enclosure having an interior configured to house an electronic device with a touchscreen in such a way that the touchscreen of the electronic device is adjacent to a first side of the first waterproof enclosure. The first side of the first waterproof enclosure has a non-rigid transparent membrane and the non-rigid transparent membrane is configured to allow a user to interact with the touchscreen of the electronic device. The apparatus also includes a second waterproof enclosure that houses a control module. The control module is configured to be operatively coupled to the electronic device and an external auxiliary device. The apparatus further includes a pressure balancing module coupled to the first waterproof enclosure. The pressure balancing module is configured to balance pressure within the first waterproof enclosure relative to external ambient conditions. The first and second waterproof enclosures are physically coupled together. An internal pressure of the first waterproof enclosure enables the non-rigid transparent membrane of the first waterproof enclosure to remain within a predetermined distance to the touchscreen of the electronic device. The predetermined distance is one that allows the touchscreen of the electronic device to receive inputs from the user via the non-rigid transparent membrane.

### CROSS-REFERENCE TO RELATED APPLICATIONS

This application claims priority to U.S. Provisional Patent Application No. 63/227,662, filed on Jul. 30, 2021, entitled “UNDERWATER DEPTH COMPENSATOR FOR SMARTPHONE-SIZE TOUCHSCREEN DEVICES,” the disclosure of which is incorporated herein by reference in its entirety.

### TECHNICAL FIELD

The present invention relates generally to the field of apparatuses for use with communication devices. More specifically, the present invention relates in one exemplary embodiment to an underwater communication interface allowing an electronic device having a touchscreen to be used while underwater.

### DISCUSSION OF THE BACKGROUND

Few solutions exist in the prior art that allow scuba divers or other individuals to communicate with each other while underwater. Known underwater communication techniques include use of hand signals or underwater writing boards. However, these techniques require the existence of light and the individuals communicating must be in very close proximity to each other.

Specialized acoustic communication systems (sometimes referred to as underwater telephones) have been developed that employ various kinds of audio microphones, amplifiers, and receivers that allow individuals to communicate underwater. For example, it is known to use a bone-conduction transducer device attached to one diver's face mask to convert the diver's voice into an ultrasound signal that is sent to a transceiver device of another diver, which then converts such signal back into sound that the receiving diver can hear. In this fashion, divers can communicate with each other through speech using acoustic signals while underwater.

Electronic devices having touchscreens are now ubiquitous and are a convenient way to communicate with others, take pictures, provide access to and process information, and the like. In normal operation above water, a touchscreen device is operated through a thin waterproof membrane. However, when a touchscreen device is submerged underwater the water pressure pushes the membrane against the touchscreen rendering it inoperable. Furthermore, as water pressure increases relative to water depth, the increasing pressure eventually will break the touchscreen regardless of whether a waterproof membrane is present or not.

An electronic device with a touchscreen can be housed in a waterproof rigid enclosure to prevent the touchscreen from breaking when submerged underwater. However, when enclosed in a rigid enclosure, the touchscreen cannot be accessed by a user's fingers, thus rendering normal use of the device while underwater impossible. Moreover, given limitations on underwater data transmission, it is extremely difficult to wirelessly transmit data between electronic devices when submerged underwater. For example, Bluetooth has limited above-water transmission range, and underwater, this range is reduced to impractically short distances.

Each of the aforementioned techniques and devices suffer from one or more disadvantages that make them unsuitable for using electronic devices having a touchscreen to send and receive communications while underwater.

Based on the foregoing, there is still a need for an underwater communication interface apparatus that allows a user to use the touchscreen of an electronic device to send and receive data while underwater.

### SUMMARY

The present invention seeks to provide a solution to the aforementioned problems by using a pressure-balanced enclosure to house an electronic device with a touchscreen to enable a user to engage in bidirectional communication underwater at any depth.

According to an embodiment, there is an underwater communication interface apparatus, which includes a first waterproof enclosure having an interior configured to house an electronic device with a touchscreen in such a way that the touchscreen of the electronic device is adjacent to a first side of the first waterproof enclosure. The first side of the first waterproof enclosure has a non-rigid transparent membrane and the non-rigid transparent membrane is configured to allow a user to interact with the touchscreen of the electronic device. The apparatus also includes a second waterproof enclosure that houses a control module. The control module is configured to be operatively coupled to the electronic device and an external auxiliary device. The apparatus further includes a pressure balancing module coupled to the first waterproof enclosure. The pressure balancing module is configured to balance pressure within the first waterproof enclosure relative to external ambient conditions. The first and second waterproof enclosures are physically coupled together. An internal pressure of the first waterproof enclosure enables the non-rigid transparent membrane of the first waterproof enclosure to remain within a predetermined distance to the touchscreen of the electronic device. The predetermined distance is one that allows the touchscreen of the electronic device to receive inputs from the user via the non-rigid transparent membrane.

According to another embodiment, there is an underwater communication interface apparatus having a modem and a control module having a wireless communication interface configured to wirelessly communicate. The apparatus also has a first waterproof enclosure having a rigid housing member moveably coupled to a rigid frame member such that the first waterproof enclosure has an open position and a closed and sealed position. An interior of the first waterproof enclosure is configured to house an electronic device with a touchscreen in such a way that the touchscreen of the electronic device is adjacent to a first side of the first waterproof enclosure. The first side of the first waterproof enclosure includes the rigid frame member surrounding a non-rigid transparent membrane. The non-rigid transparent membrane is positioned adjacent to the touchscreen of the electronic device and the non-rigid transparent membrane is configured to allow a user to interact with the touchscreen of the electronic device. The apparatus also has a second waterproof enclosure that houses the control module, which is operatively coupled to the modem and is configured to be operatively coupled to the electronic device. The apparatus further has a pressure balancing module coupled to the first waterproof enclosure. The pressure balancing module is configured to balance pressure within the first waterproof enclosure relative to external ambient conditions. The first and second waterproof enclosures are physically coupled together. An internal pressure of the first waterproof enclosure enables the non-rigid transparent membrane of the first waterproof enclosure to remain within a predetermined distance to the touchscreen of the electronic device. The predetermined distance is one that allows the touchscreen of the electronic device to receive inputs from the user via the non-rigid transparent membrane.

In accordance with yet another embodiment, there is an underwater communication interface apparatus having a common waterproof enclosure with an interior configured to house an electronic device with a touchscreen in such a way that the touchscreen of the electronic device is adjacent to a first side of the first waterproof enclosure. The first side of the first waterproof enclosure has a non-rigid transparent membrane and the non-rigid transparent membrane is configured to allow a user to interact with the touchscreen of the electronic device. The common waterproof enclosure also houses a control module which is configured to be operatively coupled to the electronic device and an external auxiliary device. The apparatus also includes pressure balancing module coupled to the common waterproof enclosure. The pressure balancing module is configured to balance pressure within the common waterproof enclosure relative to external ambient conditions. The common waterproof enclosure houses the electronic device and the control module in a common compartment or in separate compartments. An internal pressure of the common waterproof enclosure enables the non-rigid transparent membrane of the common waterproof enclosure to remain within a predetermined distance to the touchscreen of the electronic device. The predetermined distance is one that allows the touchscreen of the electronic device to receive inputs from the user via the non-rigid transparent membrane.

In one variant, the electronic device and control module are in wireless communication with each other via Bluetooth. In other variants, the control module is operatively coupled to the external auxiliary device that is an acoustic modem. In yet other variants, the control module further comprises a water sensor in operative contact with ambient water to measure ambient water conditions.

Utilization of pair of the underwater communication interface apparatuses according of the present invention, enables users to interface normally with the touchscreen of an electronic device (such as a smartphone) to thereby send and receive communications, messages and/or data while underwater at any depth. Other features and advantages of the present invention will immediately be recognized by persons of ordinary skill in the art with reference to the accompanying drawings and detailed description of exemplary embodiments as discussed herein.

### BRIEF DESCRIPTION OF THE DRAWINGS

The accompanying drawings illustrate various aspects and embodiments of the present invention disclosed herein, but should not be construed as restricting the scope of the invention in any manner. In the drawings, like reference numerals refer to the same or similar elements or components.

The accompanying drawings, which are incorporated in and constitute a part of the specification, illustrate one or more embodiments and, together with the description, explain these embodiments. In the drawings:

FIG. 1 depicts a perspective front view of one embodiment of the underwater communication interface apparatus according of the present invention illustrating the first waterproof enclosure for housing an electronic device with a touchscreen separated from the second waterproof enclosure for housing a control module.

FIG. 2 depicts another perspective front view of an embodiment of the underwater communication interface apparatus according of the present invention depicted in FIG. 1 illustrating the first waterproof enclosure physically coupled to the second waterproof enclosure.

FIG. 3 depicts a perspective rear view of an embodiment of the underwater communication interface apparatus according of the present invention depicted in FIGS. 1-2 illustrating the first waterproof enclosure physically coupled to the second waterproof enclosure.

FIG. 4 depicts another perspective rear view of an embodiment of the underwater communication interface apparatus according of the present invention depicted in FIGS. 1-3 illustrating a rigid housing member moveably coupled to a rigid frame member that surrounds a non-rigid transparent membrane that is be positioned adjacent to the touchscreen of the electronic device when the rigid housing member and the rigid frame member are in a closed position.

FIG. 5 depicts a perspective cross-sectional view of one embodiment of the second waterproof enclosure that houses a control module having an optional sensor according of the present invention.

FIG. 6 depicts yet another perspective front view of an embodiment of the underwater communication interface apparatus according of the present invention depicted in FIGS. 1-5 with the first waterproof enclosure coupled to an air supply in operative communication with the pressure balancing module.

FIG. 7 depicts yet another perspective rear view of an embodiment of the underwater communication interface apparatus according of the present invention depicted in FIGS. 1-6 with the first waterproof enclosure coupled to an air supply in operative communication with the pressure balancing module.

FIG. 8 depicts yet another perspective front view of an embodiment of the underwater communication interface apparatus according of the present invention depicted in FIGS. 1-7 with the first waterproof enclosure coupled to an air supply and the second waterproof enclosure coupled to an interface cable operatively coupled to an external auxiliary device.

FIG. 9 depicts a perspective view of a pair of underwater communication interface apparatuses according of the present invention depicted in FIGS. 1-8 in communication with each other via acoustic modems to enable bidirectional communication underwater.

FIGS. 10A and 10B respectively depict a common waterproof enclosure having separate compartments and a common waterproof enclosure having a common compartment.

### DETAILED DESCRIPTION

Various aspects and embodiments of the apparatus of the present invention are now described in detail. Reference is made to the drawings, wherein like numerals refer to the same or similar parts throughout. Although the apparatus of the present invention is described primarily with respect to underwater communication between divers, the present invention may be readily adapted to other underwater communication environments as well. Hence, a myriad of other applications of the present invention are contemplated.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

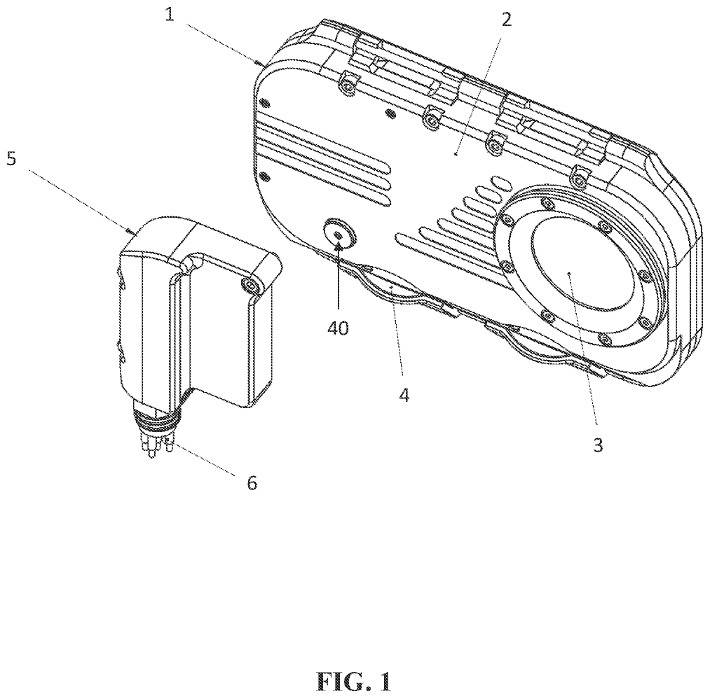

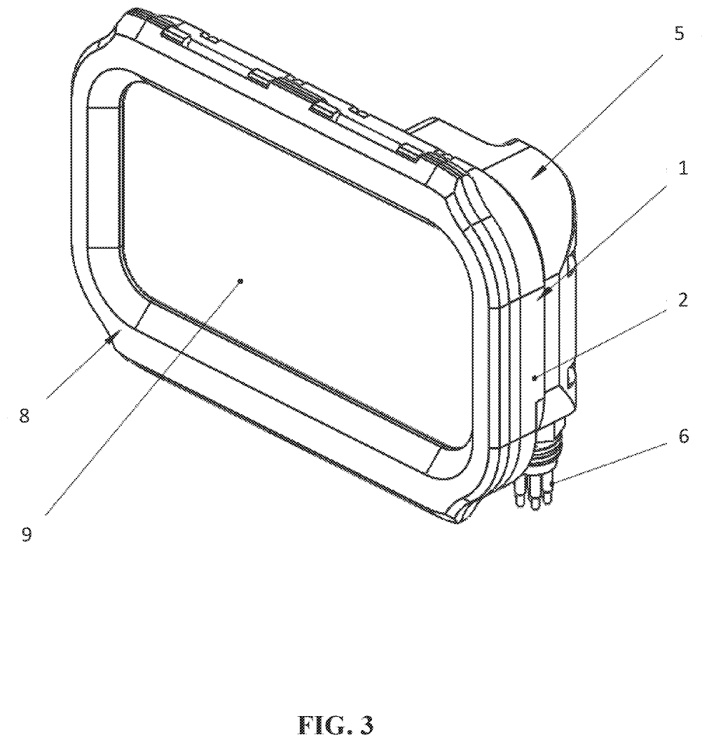

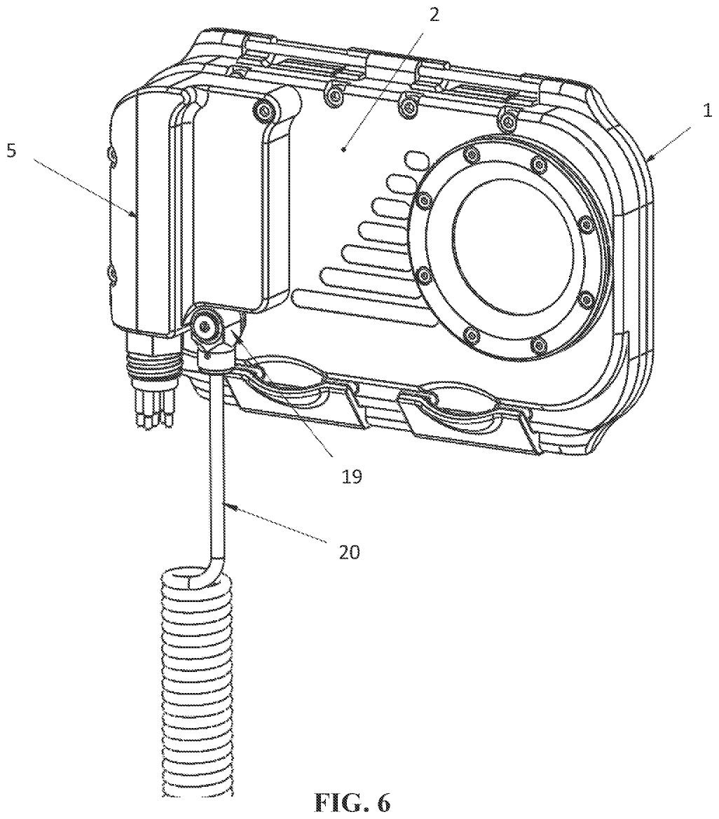

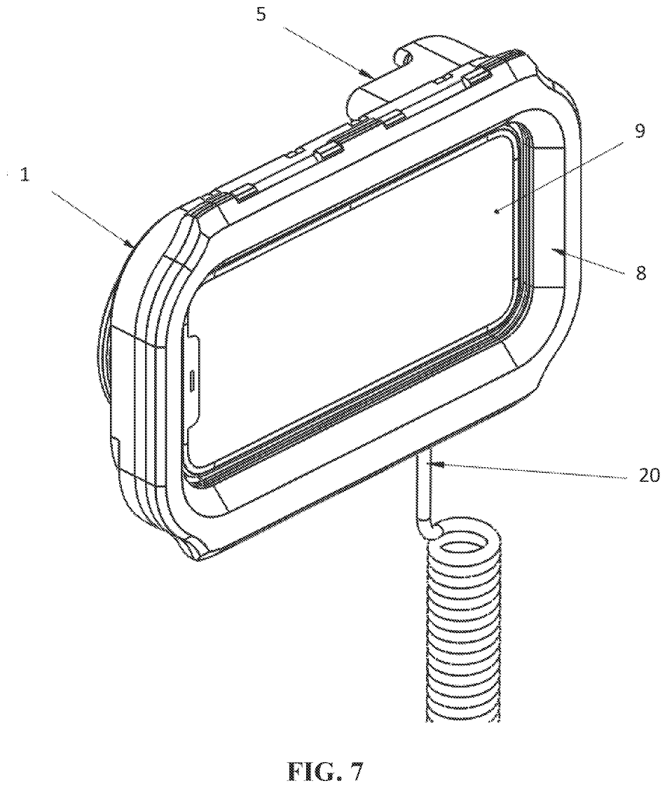

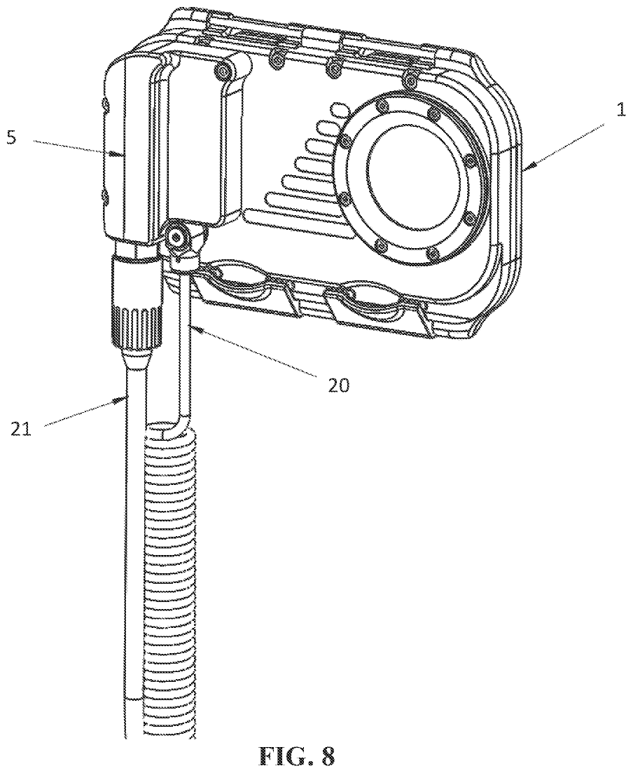

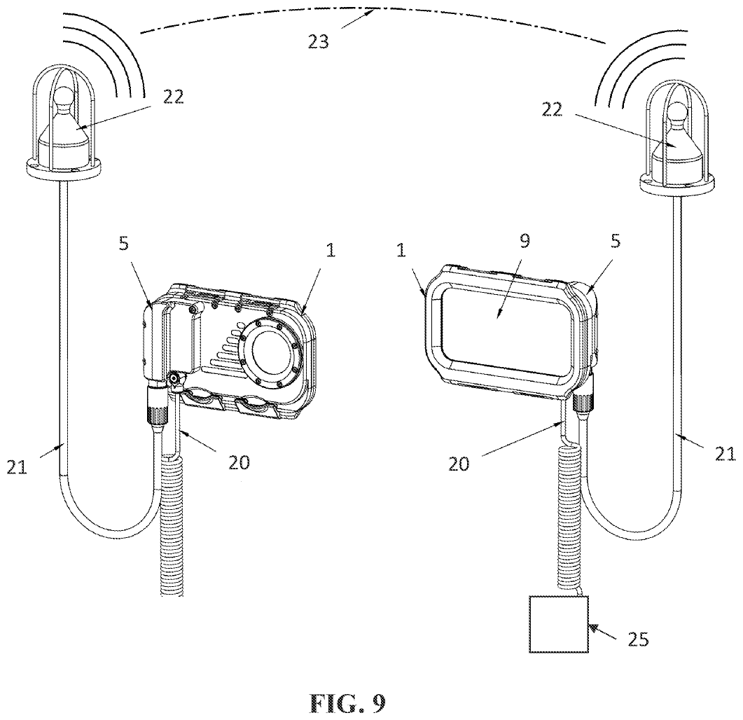

FIGS. 1-8 depict an embodiment of the underwater communication interface apparatus according to the present invention comprising a first waterproof enclosure 1 having an interior configured to house an electronic device 11 with a touchscreen, a second waterproof enclosure 5 for housing a control module 16, and a pressure balancing module 25 (illustrated in a highly schematic form in FIG. 9) coupled to the first waterproof enclosure for balancing pressure within the first waterproof enclosure 1 relative to external ambient conditions.

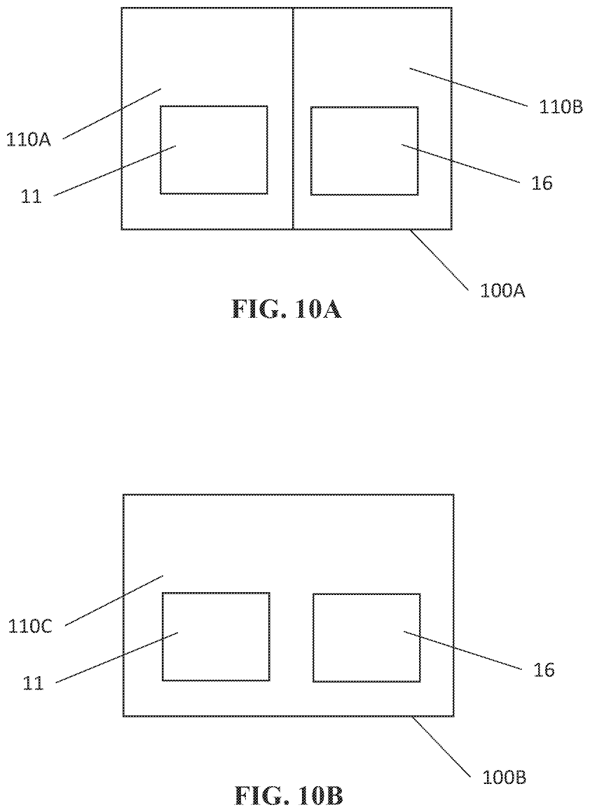

In exemplary embodiments, the first waterproof enclosure 1 and second waterproof enclosure 5 are coupled together in close proximity to one another to minimize water intrusion between the enclosures and to allow the electronic device 11 and control module 16 to be in data communication with each other. It is contemplated that the electronic device 11 and control module 16 are in wireless communication with each other via Bluetooth or alternatively are electrically linked together via a physical coupling. If the electronic device 11 and control module 16 configured to wirelessly communicate with each other, each includes a wireless communication interface to achieve the wireless communications. If the electronic device 11 and control module 16 electrically linked together via a physical coupling each includes a wired communication interface to communicate with each other. The wired and wireless communication interfaces contain circuitry to support the communications, such as an antenna, modulator/demodulator, down- or up-converter (if applicable), and other similar circuitry necessary to support the wired or wireless communications. In preferred embodiments, the first and second waterproof enclosures are closely coupled to each other with less than a 10 mm gap separating the enclosures. But, more preferably, there is less than a 1 mm gap between the enclosures. Alternatively, a common waterproof enclosure having one or more compartments 110A and 110B for separately housing the electronic device 11 and control module 16 (FIG. 10A) or having a common compartment 110C housing both the electronic device 11 and the control module 16 (FIG. 10B) can be used. When both the electronic device 11 and control module 16 are housed in a common compartment 110C of the common waterproof enclosure 110B, the control module 16 can be implemented without a sensor.

As discussed below, the control module 16 can include a sensor for sensing conditions in the water, such as water pressure. Thus, when a common waterproof enclosure is used, the sensor will either be omitted and the common compartment common waterproof enclosure of FIG. 10B is used, for example because the pressure balancing within the enclosure will prevent the sensing of water pressure, or the separate compartments 110A and 110B of the common waterproof enclosure can be sealed with respect to each other so that the pressure balancing module 25 only acts on the compartment housing the electronic device and not the compartment housing the control module. When the electronic device 11 and control module 16 are housed in a common waterproof enclosure 110B having a common compartment 110C, the common waterproof enclosure 110B should be designed so that the non-rigid transparent member 9 covers only the screen of the electronic device 11 and does not cover the control module 16.

One advantage of using separate waterproof enclosures is that the control module in the second waterproof enclosure may require a certification for the wireless communication protocol used to communicate with the electronic device. If the control module and the electronic device communicate using Bluetooth, the second waterproof housing with the control module will require Bluetooth certification. Because there may be a number of different versions of the first waterproof enclosure to accommodate electronic devices having different dimensions, having a common waterproof enclosure may require a certification of each version of the common waterproof enclosure, which would not be required if the control module is housed in a separate, second waterproof enclosure.

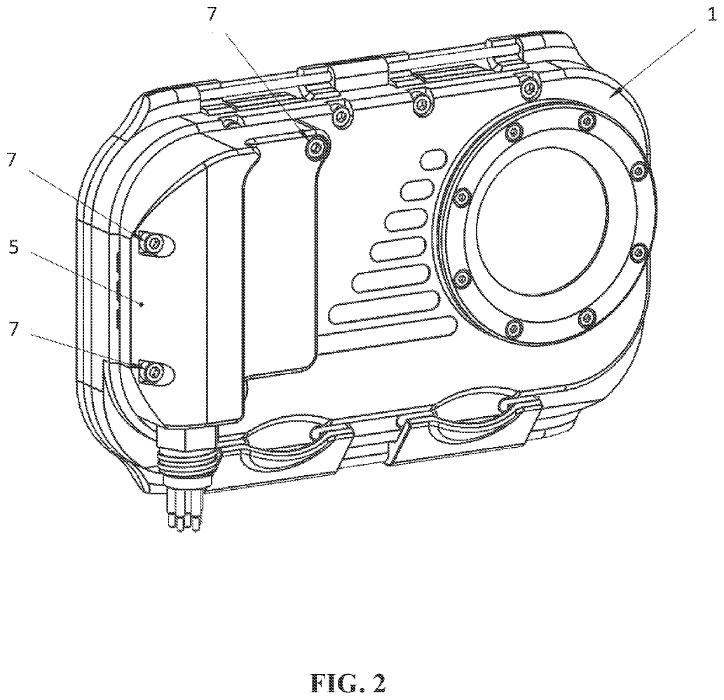

As shown in FIG. 2, the first and second waterproof enclosures are coupled together with a plurality of screws 7. However, in alternative embodiments, the first and second waterproof enclosures can be secured together with magnetic, snap, or any other couplings or connectors that are suitable to securely couple the enclosures together.

First waterproof enclosure 1 has a rigid housing member 2 moveably coupled (e.g., hingedly coupled) to a rigid frame member 8 so that the members can be moved between open and closed positions of the first waterproof enclosure 1. In the close position, the first waterproof enclosure 1 is sealed from the environment, i.e., is waterproof and prevents water infiltration into the interior of the first waterproof enclosure 1. Further, rigid frame member 8 surrounds a non-rigid transparent membrane 9 that is configured to be positioned adjacent to the touchscreen of the electronic device 11 when the housing member 2 and frame member 8 are in a closed position relative to one another. Specifically, the non-rigid transparent membrane 9 is arranged on a first side of the first waterproof enclosure 1. Non-rigid transparent membrane 9 allows a user normal touch access to the touchscreen of electronic device 11, through the membrane 9 while underwater. Specifically, depending upon the touch technology of the electronic device 11, the non-rigid transparent membrane 9 can allow for resistive or capacitive sensing by the touchscreen of the electronic device by a user touching the non-rigid transparent membrane 9. The pressure balancing module 25 maintains an internal pressure of the first waterproof enclosure 1 that allows the non-rigid transparent membrane 9 to remaining within a predetermined distance range of the touchscreen of the electronic device 11 to allow the touchscreen to receive inputs from a user via the non-transparent membrane 9. Further, non-rigid transparent membrane 9 also provides a user with visual access to the touchscreen of the electronic device 11 while underwater.

As shown in FIGS. 1, 6 and 8, rigid frame member 8 further includes port 40, which is coupled to sealed fitting 19 that is connected to air tube 20. Port 40 penetrates a wall of the rigid housing member 2 to enable air to be supplied from air tube 20 to an interior portion of the first waterproof enclosure 1. The internal pressure of the first waterproof enclosure 1 is maintained and controlled by the pressure balancing module 25 coupled to the air tube 20.

The internal pressure of the first waterproof enclosure 1 is maintained by the pressure balancing module 25 relative to ambident water pressure. In preferred embodiments, the internal pressure is maintained to be equivalent to or slightly higher than the ambident water pressure. It is contemplated that the internal pressure can be between 0.1 psi to 0.5 psi higher than ambient conditions, but other pressure differentials are contemplated. The internal pressure higher relative to ambient water pressure is also dependent on the size and thickness of the non-rigid transparent membrane. By maintaining the internal pressure of the first waterproof enclosure 1 in the aforementioned fashion, the touchscreen of the electronic device 11 can be submerged in water at any depth without risk of collapsing the touchscreen of the electronic device 11. Further, by maintaining the internal pressure of the first waterproof enclosure 1 in the aforementioned fashion, the non-rigid transparent membrane 9 of the first waterproof enclosure 1 can held in close proximity (including but not limited to several millimeters) to the touchscreen of the electronic device 11 to thereby enable the user to interact with the touchscreen of the electronic device 11 through membrane 9 while underwater. In preferred embodiments, it is contemplated that the spacing between membrane 9 relative to the touchscreen of the electronic device 11 is no more than several millimeters.

In exemplary embodiments, the pressure balancing module 25 of the present invention comprises the adaptive pressure balancer disclosed in U.S. Pat. No. 10,281,933 to Pena et al, issued on May 7, 2019, entitled “Adaptive Pressure Balancer.” The foregoing prior art reference to Pena and all other extraneous materials discussed herein are incorporated herein by reference in their entirety. Where a definition or use of a term in an incorporation reference is inconsistent or contrary to the definition of that term provided herein, the definition of that term provided herein applies and the definition of that term in the reference does not apply.

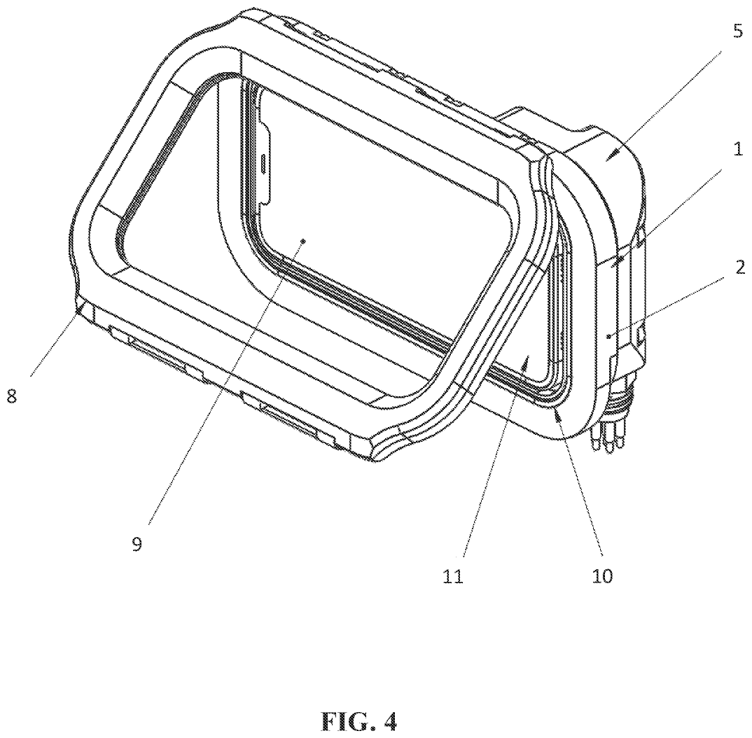

As shown in FIG. 4, rigid housing member 2 and rigid frame member 8 are shown in an open position and the electronic device with touchscreen is installed within housing member 2. First waterproof enclosure 1 further includes one or more latching mechanisms 4 so that rigid housing member 2 can be securely closed in watertight fashion to rigid frame member 8 through the use of seal 10. Latching mechanisms 4 can include securing screws, friction latches, over-centering latches, cam latches, or any other latching mechanisms that are suitable to securely close housing member 2 to rigid frame member 8. It is further contemplated that rigid housing member 8 has a transparent opening 3 that is aligned with the camera on the electronic device 11. The transparent opening 3 is arranged on the rigid housing member 8 so that the transparent opening 3 is unobscured by the second waterproof enclosure 5, which in turn provides the camera of the electronic device 11 with an unobscured view of the surrounding environment.

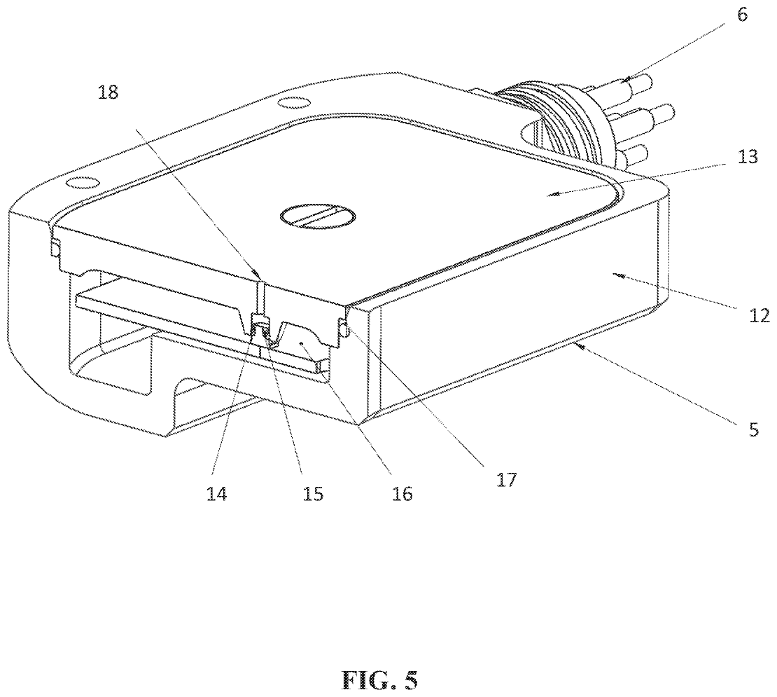

As shown in FIG. 5, the second waterproof enclosure 5 for housing control module 16 comprises a rigid housing 12, cover portion 13, and seal portion 17. It is contemplated that the second waterproof enclosure 5 is a non-pressure balanced enclosure designed to resist water ingress and pressure. In preferred embodiments, control module 16 includes at least one sensor 15. Sensor 15 is sealed relative to cover 13 with seal 14. Water enters opening 18 in cover 13 to contact sensor 15. Sensor 15 allows the control module 16 to monitor various aspects of ambient water conditions, including, but not limited to, pressure, temperature, salinity, and other environmental conditions.

Control module 16 is further configured to control and/or communicate with one or more external auxiliary device 22. The external auxiliary device 22 can be an acoustic modem that communicates information by generating modulated acoustic signals. Alternatively, external auxiliary device 22 can be an optical device modem that modulates information using onto light that is projected into the environment.

Still further, second waterproof enclosure 5 is further configured to include a water tight coupling 6 that enables control module 16 to be operatively coupled to external auxiliary device 22 via interface cable 21. However, it is contemplated that control module 16 can be wirelessly connected to external auxiliary device 22. Communications, inputs, commands, messages, and/or data entered through the touchscreen on electronic device 11 are sent to control module 16 via the aforementioned Bluetooth or wired communication link, and then sent to the external auxiliary device 22 via interface cable 21. Interface cable 21 can also transmit communications, inputs, commands, and/or data received by external auxiliary device 22 back to control module 16 that are received, including, from other underwater communication interface apparatus according to the present invention.

FIG. 9 depicts a pair of the underwater communication interface apparatuses according of the present invention that are in data communication with each other via the use of acoustic modems. The pair of apparatuses enables users to interface normally with a touchscreen electronic device (such as a smartphone) to send and receive messages and/or data while underwater at any depth.

Thus, specific embodiments of an underwater communications interface apparatus have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprising,” “comprises,” and “comprise” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C, . . . and N, the text should be interpreted as requiring only one element from the group, not A plus N, or B plus N, etc.

The disclosed embodiments provide an underwater communications interface apparatus. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCE

U.S. Pat. No. 10,281,933 to Pena et al.

1. An underwater communication interface apparatus comprising:
a first waterproof enclosure having an interior configured to house an electronic device with a touchscreen in such a way that the touchscreen of the electronic device is adjacent to a first side of the first waterproof enclosure, wherein the first side of the first waterproof enclosure has a non-rigid transparent membrane, and wherein the non-rigid transparent membrane is configured to allow a user to interact with the touchscreen of the electronic device;
a second waterproof enclosure that houses a control module, wherein the control module is configured to be operatively coupled to the electronic device and an external auxiliary device; and
a pressure balancing module coupled to the first waterproof enclosure, wherein the pressure balancing module is configured to balance pressure within the first waterproof enclosure relative to external ambient conditions;
wherein the first and second waterproof enclosures are physically coupled together; and
wherein an internal pressure of the first waterproof enclosure enables the non-rigid transparent membrane of the first waterproof enclosure to remain within a predetermined distance to the touchscreen of the electronic device, wherein the predetermined distance is one that allows the touchscreen of the electronic device to receive inputs from the user via the non-rigid transparent membrane.

2. The apparatus of claim 1, wherein the control module is operatively coupled to an interface cable that is operatively coupled to the external auxiliary device.

3. The apparatus of claim 2, wherein the external auxiliary device comprises an acoustic modem configured to receive and transmit acoustic signals.

4. The apparatus of claim 3, wherein the control module is configured to process data received from the acoustic modem.

5. The apparatus of claim 2, wherein the external auxiliary device comprises an optical device configured to transmit and receive optical signals.

6. The apparatus of claim 5, wherein the control module is configured to process data received from optical device.

7. The apparatus of claim 1, wherein the control module further comprises a water sensor.

8. The apparatus of claim 1, wherein the control module is configured to communicate with the electronic device using wireless communications.

9. The apparatus of claim 1, wherein the control module includes a physical coupling configured to electrically link the control module to the electronic device.

10. The apparatus of claim 1, wherein the first waterproof enclosure further comprises a rigid housing member and a rigid frame member, and wherein the rigid housing member is moveably coupled to the rigid frame member to allow the user to move the members between open and closed positions.

11. The apparatus of claim 10, wherein the rigid housing member is configured to receive the electronic device, and wherein the rigid frame member surrounds the non-rigid transparent membrane so that the transparent membrane is positioned adjacent to the touchscreen of the electronic device when the rigid housing member and the rigid frame member are in the closed position.

12. The apparatus of claim 1, wherein the second waterproof enclosure further comprises a rigid housing, a cover portion, and a seal portion, and wherein the second waterproof enclosure further comprises an opening in the cover to allow water to contact the water sensor.

13. The apparatus of claim 1, wherein the first waterproof enclosure further comprises a port configured to be coupled to an air tube that is operatively coupled to the pressure balancing module, wherein the port penetrates a wall of the first waterproof enclosure to allow air to be supplied to an interior portion of the first waterproof enclosure to control an internal pressure of the first waterproof enclosure.

14. The apparatus of claim 13, wherein the internal pressure of the first waterproof enclosure relative to an ambident water pressure is maintained to be equivalent to or slightly higher than the ambident water pressure.

15. An underwater communication interface apparatus comprising:
a modem;
a control module having a wireless communication interface configured to wirelessly communicate;
a first waterproof enclosure comprising a rigid housing member moveably coupled to a rigid frame member such that the first waterproof enclosure has an open position and a closed and sealed position, wherein an interior of the first waterproof enclosure is configured to house an electronic device with a touchscreen in such a way that the touchscreen of the electronic device is adjacent to a first side of the first waterproof enclosure, wherein the first side of the first waterproof enclosure includes the rigid frame member surrounding a non-rigid transparent membrane, wherein the non-rigid transparent membrane is positioned adjacent to the touchscreen of the electronic device, and wherein the non-rigid transparent membrane is configured to allow a user to interact with the touchscreen of the electronic device;
a second waterproof enclosure that houses the control module, wherein the control module is operatively coupled to the modem and is configured to be operatively coupled to the electronic device; and
a pressure balancing module coupled to the first waterproof enclosure, wherein the pressure balancing module is configured to balance pressure within the first waterproof enclosure relative to external ambient conditions;
wherein the first and second waterproof enclosures are physically coupled together; and
wherein an internal pressure of the first waterproof enclosure enables the non-rigid transparent membrane of the first waterproof enclosure to remain within a predetermined distance to the touchscreen of the electronic device, wherein the predetermined distance is one that allows the touchscreen of the electronic device to receive inputs from the user via the non-rigid transparent membrane.

16. The underwater communication interface apparatus of claim 15, wherein the modem is an optical modem configured to transmit and receive optical signals.

17. The underwater communication interface apparatus of claim 15, wherein the modem is an acoustic modem configured to transmit and receive acoustic signals.

18. The underwater communication interface apparatus of claim 15, wherein the first and second waterproof enclosures are physically coupled together and the second waterproof enclosure is secured to the rigid housing member of the first waterproof enclosure.

19. The underwater communication interface apparatus of claim 18, wherein the rigid housing member of the first waterproof enclosure includes a transparent opening configured to be aligned with a camera of the electronic device, wherein the transparent opening is unobscured by the second waterproof enclosure.

20. An underwater communication interface apparatus comprising:
a common waterproof enclosure having an interior configured to house an electronic device with a touchscreen in such a way that the touchscreen of the electronic device is adjacent to a first side of the first waterproof enclosure, wherein the first side of the first waterproof enclosure has a non-rigid transparent membrane, and wherein the non-rigid transparent membrane is configured to allow a user to interact with the touchscreen of the electronic device, wherein the common waterproof enclosure also houses a control module, wherein the control module is configured to be operatively coupled to the electronic device and an external auxiliary device;
a pressure balancing module coupled to the common waterproof enclosure, wherein the pressure balancing module is configured to balance pressure within the common waterproof enclosure relative to external ambient conditions;
wherein the common waterproof enclosure houses the electronic device and the control module in a common compartment or in separate compartments; and
wherein an internal pressure of the common waterproof enclosure enables the non-rigid transparent membrane of the common waterproof enclosure to remain within a predetermined distance to the touchscreen of the electronic device, wherein the predetermined distance is one that allows the touchscreen of the electronic device to receive inputs from the user via the non-rigid transparent membrane.
